(19) United States
(12) Patent Application Publication
(10) Pub. No.: US 2007/0246675 A1
(43) Pub. Date: Oct. 25, 2007

(54) Sill cock assembly

(76) Inventor: Justin Pearson, Douglas, TX (US)

Correspondence Address: MICHAEL L. DIAZ, P.C., 555 REPUBLIC DRIVE, SUITE 200, PIANO, TX, 75074, US

(21) Appl. No.: 11/407,625

(22) Filed: Apr. 20, 2006

(51) Int. Cl. F16L 29/00

(52) U.S. Cl. 251/151

(57) ABSTRACT

A sill cock assembly for attachment to a pipe. The sill cock assembly includes a main body having a first end. A faucet is located at an opposite second end. A bore runs through the main body from the first end to the second end. A plurality of o-rings is located on an inner surface of the main body surrounding the bore. The o-rings are annularly aligned around the bore. In addition, a plurality of set screw bores run from an outer surface of the main body to the inner surface of the main body. Set screws are positioned within the set screw bores. A pipe is positioned within the bore and the plurality of set screws are tightened to secure the sill cock assembly in place upon the pipe. In an alternate embodiment, the assembly may include a threaded end for attachment to another device in place of the faucet.

### BACKGROUND OF THE INVENTION

1. Field of the Invention

This invention relates to plumbing devices. Specifically, and not by way of limitation, the present invention relates to a sill cock assembly providing ease in attachment to a pipe.

2. Description of the Related Art

It is quite common during construction of buildings and houses that water pipes to be used outside of the building or houses are extended through walls. These pipes are normally located near ground level and allow for attachment of faucets after the construction is complete. In present practice, the pipes are heated and a steel cock or a copper stub is used to attach faucets to outlet pipes during construction.

There are a wide variety of connection means for various types of faucets. To understand the present invention, terms are defined as follows. A sill cock is a complete faucet of a type utilized on water pipes which extend from inside to outside of buildings. Usually, the pipes are located near sills or bottom portions of buildings. Faucets are often referred to as cocks. Thus, the term sill cock is used to indicate an outside faucet. A spigot is normally utilized to regulate the flow of water through the faucet or sill cock.

Although current practice requires heating the pipe to properly and securely affix the sill cock to the pipe, there are problems associated with this practice. When heating the pipe, significant damage may result to the wall region located near the heated pipe. In particular, walls constructed of vinyl siding or other softer material are susceptible to heat damage. Because of this particular problem, installation of the sill cock is difficult and tedious for the builder.

Thus, it would be a distinct advantage to have a sill cock assembly allowing the installation of the sill cock assembly to a pipe without heating the pipe. It is an object of the present invention to provide such an apparatus.

### SUMMARY OF THE INVENTION

In one aspect, the present invention is a sill cock assembly for attachment to a pipe. The sill cock assembly includes a main body having an outer flange located on a first end. A faucet is located at an opposite second end. A bore runs through the main body from the first end to the second end. A plurality of o-rings is located on an inner surface of the main body surrounding the bore. The o-rings are annularly aligned around the bore. In addition, a plurality of set screw bores run from an outer surface of the main body to the inner surface of the main body. Set screws are positioned within the set screw bores. The sill cock assembly is attached to a pipe by positioning the pipe within the bore and the plurality of set screws are tightened about the pipe.

In another aspect, the present invention is a sill cock assembly which includes a main body having an outer flange located on a first end. A faucet having a spigot for selectively opening the faucet is located at an opposite second end. A bore runs through the main body from the first end to the second end. A plurality of o-rings is located on an inner surface of the main body surrounding the bore. The o-rings reside within annular grooves annularly aligned around the bore. Three set screw bores run from an outer surface of the main body to the inner surface of the main body. The set screw bores are spaced 120 degrees apart from each other. Three Allen socket cap set screws are positioned within the plurality of set screw bores. Anchor bores located on the outer flange are used for securing the sill cock assembly to a flat surface. The sill cock assembly is attached to a pipe by positioning the pipe within the bore and the plurality of set screws are tightened about the pipe.

In still another aspect, the present invention is a connector assembly for connecting a pipe to another device. The connector assembly includes a main body having an outer flange located on a first end and a threaded opposite second end. A bore runs through the main body from the first end to the second end. A plurality of o-rings is located on an inner surface of the main body surrounding the bore. The plurality of o-rings is annularly aligned around the bore. A plurality of set screw bores run from an outer surface of the main body to the inner surface of the main body. Set screws are positioned within the plurality of set screw bores. The connector is affixed to a pipe by positioning the pipe within the bore and the set screws are tightened about the pipe. Another device may be attached to the threaded end.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a side cutaway view of a sill cock assembly in the preferred embodiment of the present invention;

FIG. 2 is a rear cutaway view of the sill cock assembly of FIG. 1;

FIG. 3 is a side cutaway view of the sill cock assembly of FIG. 1 with a pipe positioned in the bore in the preferred embodiment of the present invention;

FIG. 4 is a side cutaway view of a connector assembly in an alternate embodiment of the present invention; and

FIG. 5 is a rear view of the connector assembly of FIG. 4.

### DESCRIPTION OF THE INVENTION

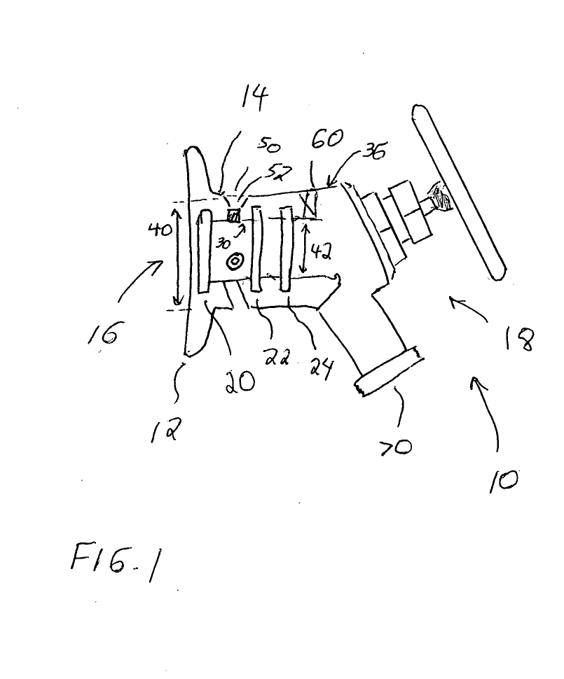

A sill cock assembly allowing ease in installation to a water pipe is disclosed. FIG. 1 is a side cutaway view of a sill cock assembly 10 in the preferred embodiment of the present invention. The sill cock assembly includes an outer flange 12, a main body 14 having a bore 16 leading to a faucet 18. The sill cock assembly also includes a spigot to selectably regulate the flow of water through the faucet. In the preferred embodiment of the present invention, the bore includes three o-rings, an outer o-ring 20, a middle o-ring 22, and an inner o-ring 24. The o-rings each reside in an annular groove located on an inner surface 30 of the main body surrounding the bore, thereby allowing the o-rings to remain seated upon the inner surface of the main body. The bore preferably has a outer diameter 40 of 1 1/16 inches and an inside diameter 42 of 11/16 of an inch.

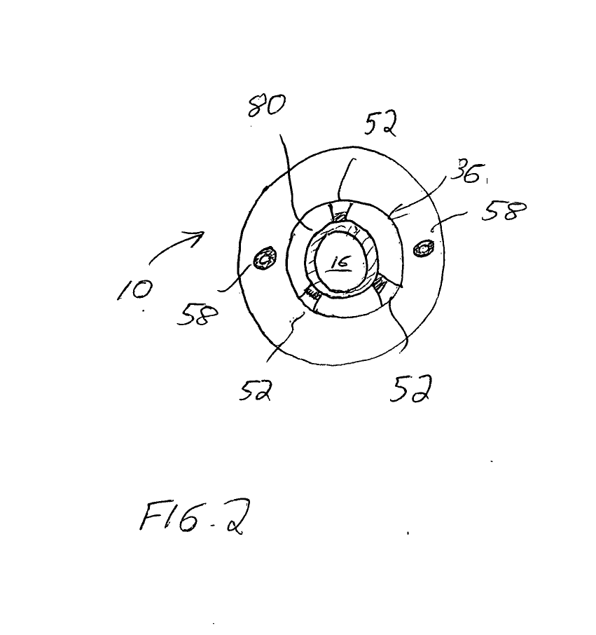

The sill cock assembly also includes a plurality of set screws 50. Preferably, the set screw is an Allen socket cap set screw ⅛″-20× 15/32″ stainless steel. The set screw runs from an outer surface 36 of the main body to the inner surface 30. The set screws are preferably arranged 120 degrees apart with the first set screw positioned at a 12 o'clock position (see FIG. 2).

The sill cock assembly also includes a weep hole 60. Preferably, the weep hole bore is angled at a 65 degree angle toward a spout 70 of the sill cock assembly. The diameter of the weep hole is approximately 3/16 of an inch on its bottom portion.

FIG. 2 is a rear cutaway view of the sill cock assembly 10 of FIG. 1. The set screws 50 are positioned within bore holes 52. The set screws are preferably arranged 120 degrees apart from each other. The sill cock assembly may also optionally include beveled anchor holes 58 for utilizing screws to affix the sill cock assembly to a flat surface, such as the wall of the building. The screws or bolts may be affixed to a wall to insure the sill cock assembly does not move.

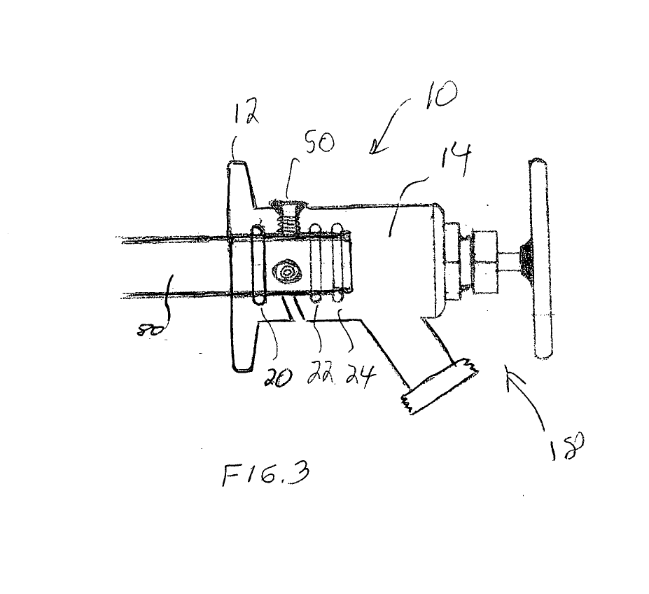

FIG. 3 is a side cutaway view of the sill cock assembly 10 of FIG. 1 with a pipe 80 positioned in the bore 16 in the preferred embodiment of the present invention. The sill cock assembly is attached to the pipe by positioning the sill cock assembly upon the pipe 80. The o-rings 20, 22, and 24 are preferably constructed of a rubber material which prevents water from leaking out from the sill cock assembly. The set screws are tightened to apply force upon the outer surface of the pipe, thereby securing the sill cock assembly to the pipe. In the preferred embodiment of the present invention, the inner o-ring is located inboard of the set screws while the middle and outer o-rings are located outboard of the set screws within the main body. The o-ring 24 is the primary o-ring which is utilized to seal against water pressure. The o-ring 22 is utilized as a back-up to the o-ring 24. The o-ring 20 is a safety o-ring which allows water to blow out the weep hole instead back into the house.

With reference to FIGS. 1-3, the operation of the sill cock assembly will now be explained. The sill cock assembly is attached to the pipe 80 by positioning the pipe into the bore 16 of the sill cock assembly. The pipe does not require heating to secure the sill cock assembly to the pipe. The set screws, positioned at 120 degrees apart from each other, are tightened about the pipe, thereby holding the sill cock assembly in place against the pipe. The o-rings 20, 22 and 24 may prevent water flowing through the pipe from leaking out the sill cock assembly.

In the preferred embodiment of the present invention, the sill cock assembly is dimensioned to fit a standard size pipe. However, it should be understood that the dimensions of the sill cock assembly may be varied for pipes of other sizes as well as providing a faucet and spout of any size desired by the builder. In addition, although three set screws are configured at 120 degrees apart, the sill cock assembly may utilize any number of set screws at any position to secure the sill cock assembly to the pipe. Three rubber o-rings are illustrated and described, but the sill cock may utilize any number of o-rings constructed of a flexible material and still remain within the scope of the present invention.

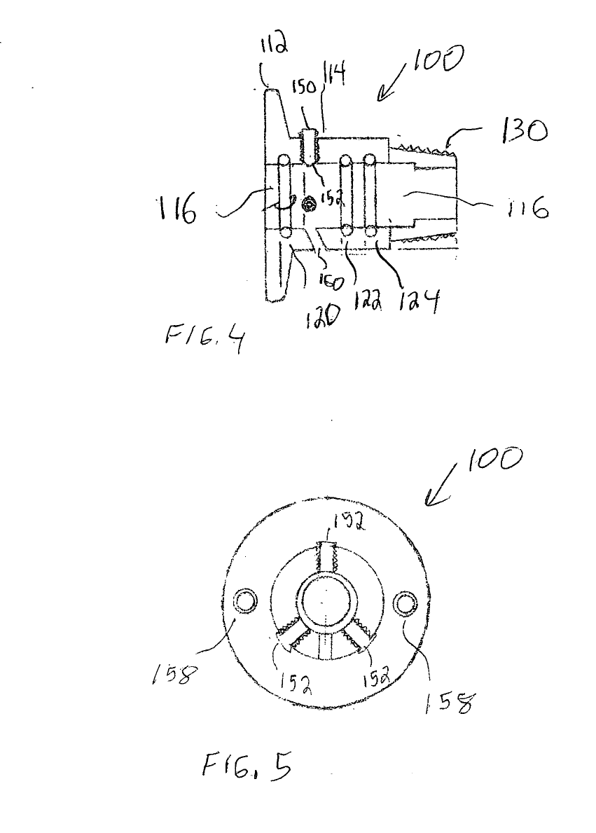

The present invention may also be utilized for securing pipes to other types of equipment. FIG. 4 is a side cutaway view of a connector assembly 100 in an alternate embodiment of the present invention. The connector assembly 100 may be utilized to secure a pipe to a boiler drain or other type of valve. The connector assembly is similar to the sill cock assembly having an outer flange 112, a main body 114, and a bore 116. In addition, the connector assembly includes an outer o-ring 120, a middle o-ring 122, and an inner o-ring 124. The connector assembly also includes a weep hole 160. The connector assembly also includes an end 130 having a threaded outer surface for attachment to another device having a female threaded end. Preferably, the threaded end is ½ of an inch in diameter but may be constructed of any size to fit any device having a threaded pipe or opening. In addition, the connector assembly also includes a plurality of set screws 150.

FIG. 5 is a rear view of the connector assembly 100 of FIG. 4. The set screws 150 are positioned at 120 degree intervals and set within bore holes 152. Although 3 set screws are show, the set screws may be any number and positioned as necessary to secure the connector assembly to the pipe. The connector assembly may also optionally include anchor holes 158 for allowing attachment of the connector assembly to another surface by inserting screws or bolts into the anchor holes. The screws or bolts may be affixed to a wall to ensure the connector assembly does not move.

The connector assembly may be utilized for attachment to a pipe and allow connection to another device, such as boiler drain or other type of valve. With a pipe positioned within the bore 116, the set screws 150 are tightened upon the pipe, thereby holding the connector assembly in place. The o-rings may also assist in preventing leakage from the pipe out through the connector assembly.

The present invention provides many advantages over existing sill cock assemblies or connectors. The present invention does not require the heating or “sweating” of a pipe, which provides difficulties in installing the sill cock assembly. Because the pipe does not need to be heated, no damage is inflicted upon the wall of the building. In addition, the present invention allows the easy removal of the sill cock assembly from the pipe as desired.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A sill cock assembly, the sill cock assembly comprising:
a main body having a first end;
a faucet having means for selectively opening the faucet located at an opposite second end;
a bore running through the main body from the first end to the second end;
a plurality of o-rings located on an inner surface of the main body surrounding the bore, the plurality of o-rings being annularly aligned around the bore;
a plurality of set screw bores running from an outer surface of the main body to the inner surface of the main body; and
a plurality of set screws positioned within the plurality of set screw bores;
whereby the sill cock assembly is attached to a pipe by positioning the pipe within the bore and the plurality of set screws are tightened to secure the sill cock assembly upon the pipe.

2. The sill cock assembly of claim 1 wherein the inner surface includes annular grooves, the plurality of o-rings being positioned within the annular grooves.

3. The sill cock assembly of claim 1 wherein the plurality of o-rings includes an inner o-ring, a middle o-ring, and an outer o-ring.

4. The sill cock assembly of claim 3 wherein the inner o-ring is positioned inboard of the plurality of set screws and the middle o-ring and outer o-ring are located outboard of the plurality of set screws.

5. The sill cock assembly of claim 1 wherein the plurality of set screws is three set screws.

6. The sill cock assembly of claim 5 wherein the three set screws are spaced 120 degrees apart from each other.

7. The sill cock assembly of claim 1 wherein the plurality of set screws are Allen socket cap set screws.

8. The sill cock assembly of claim 1 wherein the main body includes an outer flange located on the first end and includes anchor bores for securing the sill cock assembly to a flat surface.

9. The sill cock assembly of claim 1 wherein the means for selectively opening the faucet is a spigot.

10. The sill cock assembly of claim 1 wherein the main body includes a weep hole running from the outer surface of the main body to the inner surface of the main body, the weep hole angled at an approximately 65 degree angle toward the faucet.

11. A sill cock assembly, the sill cock assembly comprising:
a main body having an outer flange located on a first end;
a faucet having a spigot for selectively opening the faucet located at an opposite second end;
a bore running through the main body from the first end to the second end;
a plurality of o-rings located on an inner surface of the main body surrounding the bore, the plurality of o-rings residing within annular grooves annularly aligned around the bore;
three set screw bores running from an outer surface of the main body to the inner surface of the main body, the set screw bores spaced 120 degrees apart from each other;
three Allen socket cap set screws positioned within the plurality of set screw bores; and
a plurality of anchor bores for securing the sill cock assembly to a flat surface;
whereby the sill cock assembly is attached to a pipe by positioning the pipe within the bore and the plurality of set screws are tightened to secure the sill cock assembly upon the pipe.

12. A connector assembly, the connector assembly comprising:
a main body having a first end;
a threaded opposite second end;
a bore running through the main body from the first end to the second end;
a plurality of o-rings located on an inner surface of the main body surrounding the bore, the plurality of o-rings annularly aligned around the bore;
a plurality of set screw bores running from an outer surface of the main body to the inner surface of the main body; and
a plurality of set screws positioned within the plurality of set screw bores;
whereby the connector assembly is attached to a pipe by positioning the pipe within the bore and the plurality of set screws are tightened to secure the connector assembly upon the pipe.

13. The connector assembly of claim 12 wherein the inner surface includes annular grooves, the plurality of o-rings positioned within the annular grooves.

14. The connector assembly of claim 12 wherein the plurality of o-rings includes an inner o-ring, a middle o-ring and an outer o-ring.

15. The connector assembly of claim 14 wherein the inner o-ring is positioned inboard of the plurality of set screws and the middle o-ring and outer o-ring is located outboard of the plurality of set screws.

16. The connector assembly of claim 12 wherein the plurality of set screws is three set screws.

17. The connector assembly of claim 16 wherein the three set screws are spaced 120 degrees apart from each other.

18. The connector assembly of claim 12 wherein the plurality of set screws is Allen socket cap set screws.

19. The connector assembly of claim 12 wherein the first end includes an outer flange having anchor bores for securing the sill cock assembly to a flat surface.

20. The connector assembly of claim 12 wherein the main body includes a weep hole running from the outer surface of the main body to the inner surface of the main body.
